(19) United States
(12) Patent Application Publication
(10) Pub. No.: US 2021/0308502 A1
(43) Pub. Date: Oct. 7, 2021

(54) IMPROVEMENTS TO FALL PROTECTION EQUIPMENT

(71) Applicant: 3M INNOVATIVE PROPERTIES COMPANY, Sr. Paul, MN (US)

(72) Inventors: Matthew J. Blackford, Lake Elmo, MN (US); Michael A. Boraas, Zumbrota, MN (US); Ronald D. Jesme, Pylmouth, MN (US); Nitsan Ben-Gal Nguyen, Apple Valley, MN (US); Peter L. Olson, St. Paul, MN (US)

(21) Appl. No.: 17/264,178

(22) PCT Filed: Aug. 5, 2019
(86) PCT No.: PCT/IB2019/056647

§ 371 Date: Jan. 28, 2021

Related U.S. Application Data
(60) Provisional application No. 62/715,369, filed on Aug. 7, 2018.

(51) Int. Cl. A62B 35/00

(52) U.S. Cl. CPC A62B 35/0093; A62B 35/0056

(57) ABSTRACT

There is provided fall protection equipment, such as a self-retracting lifeline (SRL), including features that enable the SRL to determine a worker's location and a map of a surface on which the worker is working. There is also provided an SRL having a lifeline with a distal end for connection to a user, at least one sensor adapted to determine the tension in the lifeline, and a computing device comprising a processor and a memory.

### TECHNICAL FIELD

The present disclosure relates to improvements in various types of personal protective equipment, and specifically to fall protection equipment.

### BACKGROUND

People working at height, and in particular people whose occupation requires them to work at height, typically use fall protection equipment to mitigate the potential effects of a fall. For example, workers may wear a harness that is attached to a self-retracting lifeline, or SRL, which is in turn attached to a secure attachment point, or anchoring point. If a person falls, the SRL stops the payout of the rope or cable connected to the harness, thereby mitigating the effect of the fall. It would be useful to provide certain improvements in this area.

U.S. Patent Application Publication No. 2017/0368387 (Fife et al.) discloses a variable length SRL system that is said to prevent a user from falling off an elevated surface area. A memory stores information identifying a predefined safety perimeter associated with the area, and sensors associated with the SRL determine, in real time, a current length and orientation of the lanyard as the lanyard responds to a user moving on the area. A processor is configured to trigger a locking mechanism to selectively lock the lanyard from further extension when the current length and orientation of the lanyard exceeds the predefined safety perimeter associated with the area.

The present inventors have determined, however, that an SRL and potentially other personal protective equipment would benefit from one or more additional improvements.

### SUMMARY

Various embodiments of the present invention are described below and are in general terms set forth in the claims.

### BRIEF DESCRIPTION OF THE DRAWINGS

Certain features of the present disclosure are described with reference to the appended Figures, in which:

FIG. 1 is an elevated perspective view of a self-retracting lifeline (SRL) according to the present disclosure;

FIG. 2 is cross-sectional view of an SRL according to another embodiment of the present disclosure;

FIG. 3 is a cross-sectional view of an SRL according to another embodiment of the present disclosure;

FIG. 4 is symbolic view of a worker using an SRL on an elevated surface;

FIG. 5 is an SRL according to another embodiment of the present disclosure;

FIG. 6 is an elevated perspective view of a building with an elevated roof, and an SRL;

FIG. 7 is a plan view of an actual perimeter of an elevated surface, with a representative calculated safety perimeter shown relative to the actual perimeter; and

FIG. 8 is an elevated perspective view of a building with an elevated roof, and two workers on the roof.

### DETAILED DESCRIPTION

The following description sets forth certain preferred embodiments and variations of the invention, but that description is exemplary and not limiting. Variations of the embodiments disclosed below will be apparent to those of skill in the field.

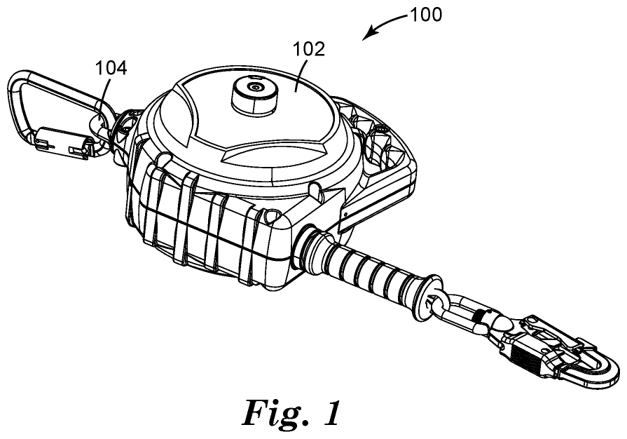

As shown in FIG. 1, an SRL 100 according to the present disclosure preferably includes a housing 102 and an anchorage point 104 that can be attached in some cases to a fixed structure such as a beam, stanchion or static line, either directly, or by a specialized connector. The housing typically surrounds a frame 106, to which is attached a drum or hub 108 on which a lifeline 110 is gathered. The lifeline may be cable, a strap, a rope, or any other suitable elongate member. The drum is biased by a spring, such that the lifeline tends to be withdrawn into the SRL and gathered on the drum when the force tending to withdraw the lifeline (typically exerted by the worker) is less than the corresponding torque of the spring tending to retract the lifeline. The terms “worker” and “user” are used interchangeably herein. One end of the lifeline is typically attached to the drum, and the free end or distal end of the lifeline is adapted to be connected to a harness work by a user or worker using a snap hook 112. The user is then free to perform activities while the lifeline extends from and retracts into the SRL automatically, which reduces slack in the line and thereby reduces the potential freefall distance for the user.

The drum, frame, and/or housing includes a mechanism, such as one or more pawls, adapted and arranged to halt the withdrawal of the lifeline in the event of a fall event, to minimize the harm to the user that such an event would otherwise cause. Examples of self-retracting lifelines include the those sold under the trade designations “ULTRA-LOK”, “NANO-LOK”^{M}, and “Smart Lock” self-retracting lifelines sold by 3M Company (St. Paul, Minn.). For purposes of the current description, reference may be made to the position of a user or worker, or to the position of the distal end of a lifeline. Because the worker is typically wearing a safety harness, and the distal end of the lifeline is attached to the harness, the two positions are essentially the same for most purposes. However, when a user may be carrying the distal end of a lifeline for purposes of teaching the SRL about an area (an aspect of the present disclosure described in detail below), reference may be made to the position of the distal end. Persons of skill in the art will recognize when the two terms are equivalent.

Additional features of the SRL of the present disclosure, which may be referred to as a “digital SRL” or “smart SRL” are preferably enabled by providing the SRL with a computing device that enables the SRL to receive and process data and to output signals that effectuate certain operations of the SRL. The computing device may include one or more processors, such as microprocessors, digital signal processors, application specific integrated circuits (ASICs), field-programmable gate arrays (FPGAs), or discrete or integrated logic circuitry. The computing device may also include one or more data storage devices to facilitate the operations of the device, and of the SRL. The processor(s) may include software or firmware stored in any suitable format or file, configured to receive and process data or information gathered from sensors or other devices and/or to output data or information or commands. Although it is preferred that the computing device be connected to and integrated with the SRL or other safety device, it could be located remotely but in communication with the SRL or other device via wired or wireless communication. In some embodiments, the computing device is accessible by users, so that a user can modify operating parameters, change default or previously input settings or information, select (as described below) a language used by the device to communicate with users, teach the device (as described below), or otherwise receive or transmit information, or both. The computing device may thus include one or more communication units or sub-systems, such as Bluetooth, optical (such as infrared), Zigbee networking, mesh networking, wireless, WiFi, or other such systems that enable person or another device to communicate with the device (such as an SRL) of the present disclosure. For example, Nordic Semiconductor part number NRF52832, available from Digi-Key Corporation (Thief River Falls, Minn.), includes a Bluetooth radio, processor, memory, and a temperature sensor, that may be useful in the context of the present disclosure. Mechanical, touch-screen, electrical contact(s), or other communication methods are also within the scope of the present disclosure.

In the present disclosure, a number of characteristics of a “digital SRL” or “smart SRL” may be important in order to enable the SRL to offer protection under certain circumstances. For example, in order to reliably establish the position of a worker, it may be insufficient for the SRL to obtain only the orientation (azimuth angle) of the SRL relative to a reference point, and the length of lifeline extended. The present disclosure includes within its scope determining the tension in the lifeline, to provide an accurate calculation of the location of a worker. A worker will be in a different position (at the end of a given length of lifeline) depending on the weight of the line, the friction in the lifeline system, and other factors as described herein. These differences can introduce error into the identified location of a worker that could compromise safety.

The tension in the lifeline may be determined in accordance with the present disclosure by determining the torque applied by the spring that retracts the lifeline, which may be related to the effective drum radius. The effective drum radius is a function of the number of layers of the lifeline that are wound on the drum, which is a function of the length of the lifeline that has been deployed, the radius of the drum, and the cross-sectional area of the lifeline. Tension may also be determined by a transducer adapted and arranged to measure the torque applied to the rotating drum by the lifeline, again preferably taking into account the effective drum radius.

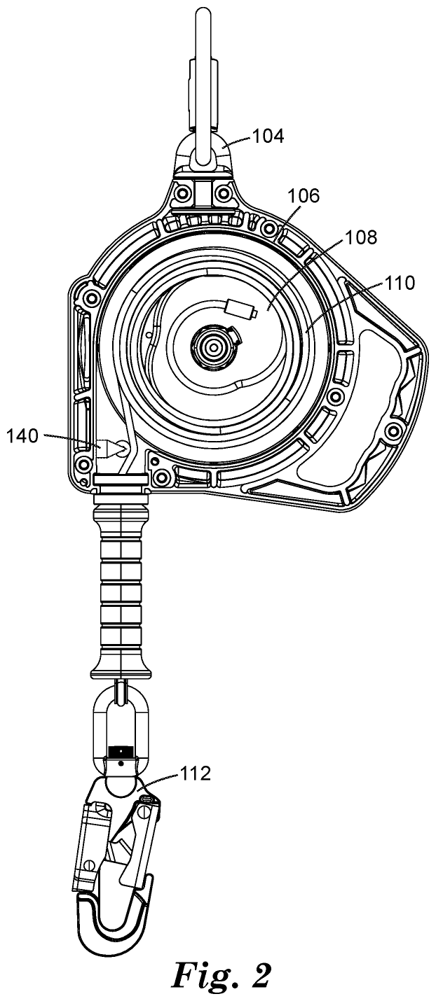

In another embodiment, the tension in the lifeline may be determined in accordance with the present disclosure by routing the lifeline around one or more tensioning rollers, gears, cogs or the like that laterally displace the lifeline, as shown for example in FIG. 2 at 140, and measuring the force applied to those components by the lifeline when in use. This approach is similar in some respects to routing the chain of a bicycle around the peripheral gears on a derailleur, and then measuring the force applied to those gears and/or the derailleur by the chain.

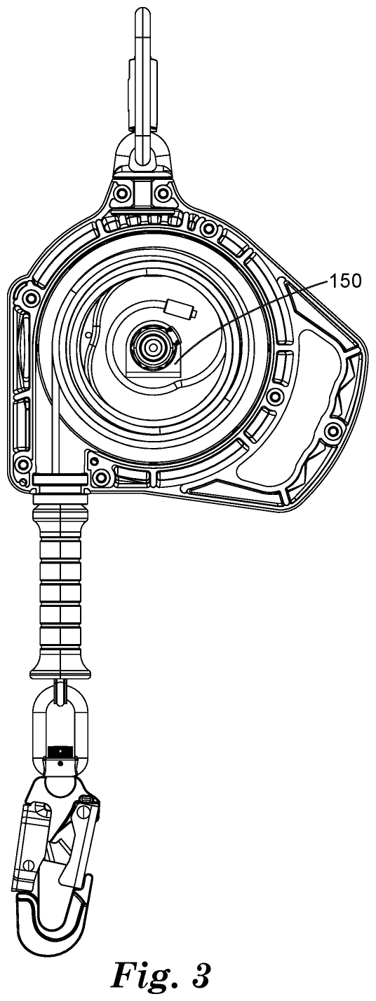

In a further embodiment, the tension in the lifeline may be determined in accordance with the present disclosure by directly measuring the force applied on the shaft of the drum by the lifeline. For example, a force transducer could be positioned adjacent one or both ends of the shaft, as shown in FIG. 3 at 150, such that the force exerted by the lifeline on the drum is detected by the transducer. One exemplary force sensor is available as TE Connectivity part number FX1901, available from Digi-Key Corporation.

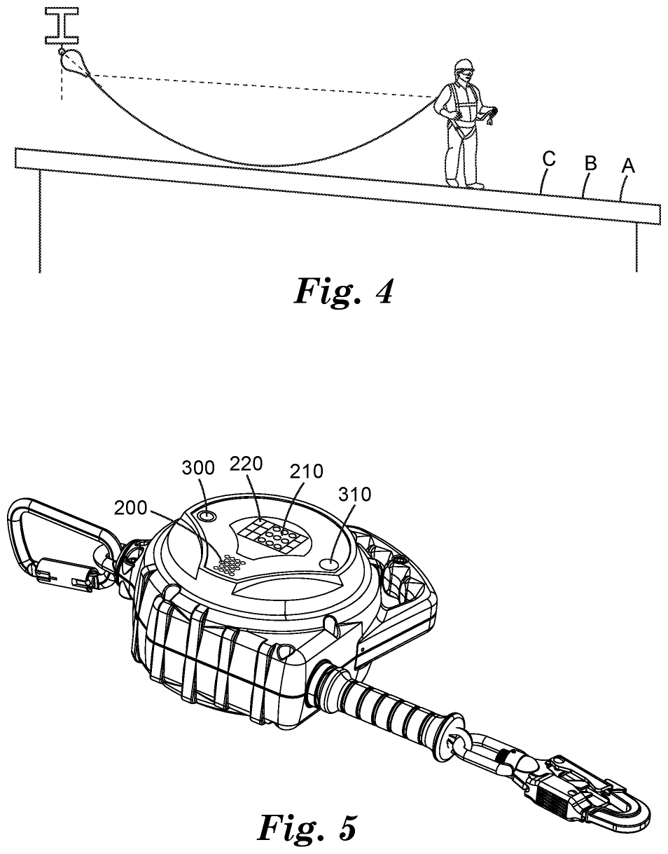

Another relevant characteristic associated with an SRL according to the present disclosure is the weight per unit length of the lifeline, because if other factors are equal, a heavier line (such as a cable) will sag more than a lighter line (such as a rope or strap), which affects the amount of slack in the lifeline. These differences can introduce error into the calculation of the location of a worker, especially where the angle of the lifeline measured relative to a vertical vector extending downward originating at the anchor point of the SRL tends towards a right angle. For example, if a worker remains at a less than 10 degree angle, or less than a 20 degree angle, the difference in position between a taut, lightweight lifeline approximation and a slack, heavy lifeline approximation is not likely to be significant. But if the worker is at a 45 degree or 60 degree angle, then particularly when the lifeline is extended a substantial distance the slack in the lifeline can be significant, as shown in FIG. 4.

In a further embodiment of the present disclosure, the SRL is adapted to account for the difference between the force applied to the lifeline when the lifeline is being extended, and the force applied to the lifeline when the lifeline is being retracted. This may be referred to as the hysteresis characteristic of the SRL. This effect may be significant because an estimate of a worker's location based on the tension in the lifeline when the worker is moving away from the SRL may be different from an estimate of a worker's location based on the tension in the lifeline when the worker is moving toward the SRL, or sequentially toward and away from the SRL. It is believed that friction would add an approximately fixed amount of friction to the tension when being extended, and subtract an approximately fixed amount of tension when being retracted, because the recoil spring has a known hysteresis function, and the SRL generally has a constant friction function, although the orientation of the SRL can affect friction.

In another embodiment of the present disclosure, the SRL is adapted to account for friction between the lifeline and one or more components of the SRL (including other portions of the lifeline, where they overlap each other). Friction in the lifeline of the SRL can be addressed by selecting low-friction materials, designed not to be affected by manufacturing variations, wear, time, or physical orientation. For example, rolling bearing elements, or lubricant-impregnated polymers can improve the accuracy of the measurement of friction.

Another relevant piece of data obtained and used in conjunction with certain embodiments of the present disclosure is the ambient temperature. Sensors such as an accelerometer or magnetometer can exhibit thermally-induced errors that can be corrected when the ambient temperature is known. Similarly, the friction associated with a system (and thus potentially the tension in a lifeline, for example) can vary due to the thermal characteristics of a lubricant, such as a lubricant used in a sealed block SRL. Accordingly, in certain embodiments of the present disclosure the device of the present disclosure includes a temperature sensor, and the algorithm used to calculate a temperature-dependent variable is provided to account for that variation in view of the ambient temperature. The Nordic Semiconductor referenced above, or a temperature sensor such as Texas Instruments part number TMP102, available from Digi-Key Corporation, may be useful in this respect.

An additional source of potential error addressed by embodiments of the present disclosure is attributable to the assumption that the lanyard extends from the anchor point (which is fixed), rather than from an SRL that is typically free to be pulled off-center from that anchor point, as shown in FIG. 4. In some SRLs, that difference alone could account for errors of 12-18 inches, with potentially harmful effects for the user if the lifeline is then permitted to extend by that unaccounted-for distance.

These and other system or measurement inaccuracies associated with conventional SRLs can result in falls that might otherwise be prevented if certain improvements are provided in accordance with the present disclosure.

An SRL in accordance with the present disclosure may calculate an estimated distance between the SRL and a worker, and thus the worker's location, in several ways. Without intending to limit the present disclosure in any respect, one way is believed to be as follows:

$$Δ x = {L}_{2} \cdot sin ( {θ}_{1} ) + \frac{{F}_{1} \cdot sin ( {θ}_{1} + {θ}_{3} )}{λ} \cdot arsinh ( cot ( {θ}_{1} + {θ}_{3} ) ) - ( \frac{{F}_{1} \cdot sin ( {θ}_{1} + {θ}_{3} )}{λ} \cdot arsinh ( cot ( {θ}_{1} + {θ}_{3} ) - \frac{{s}_{1} λ}{{F}_{1} \cdot sin ( {θ}_{1} + {θ}_{3} )} ) ) . \\ {θ}_{3} = {sin}^{- 1} ( \frac{{L}_{1} ( {m}_{0} - {s}_{1} \cdot λ ) sin {θ}_{1}}{{F}_{1} \cdot {L}_{2}} )$$

Where the variables are defined as follows:

Δx the horizontal distance from the SRL anchor point to where the lanyard attaches to the worker.

θ₁ is the angle between the vertical axis (i.e., the gravitational vector, as can be measured by a three-axis accelerometer) and a line defined by the anchor point and the center of mass of the SRL.

L₁ is the length from the top connection point of the SRL to the center of mass of the SRL.

L₂ is the length from the top connection point of the SRL to the point where the cable exits the SRL.

s₁ is the length of cable pulled from the SRL extending to the worker.

F₁ is the tension on the cable as provided by the retraction spring in the SRL, tangent to the cable at the exit point from the SRL.

m₀ is the total weight of the SRL including all cable.

λ is the weight per unit length of cable.

In another aspect of the present disclosure, an additional improvement to an SRL can be implemented if and when a worker is determined by the SRL to be nearing a safety perimeter. If the SRL locks the lifeline, the worker may be abruptly restrained, which despite sounding desirable may actually distract the worker and put himself or herself, or other nearby workers or materials, at risk. Instead, a further improvement in SRL performance is to determine two or more locations, and then to apply a progressive response, such as gradually increasing or decreasing the resistance applied by the SRL to the lifeline based on those locations. For example, the SRL may apply 10% or 20% initial resistance in the lifeline as the safety perimeter approaches, such as in FIG. 4 at point C, but 80% at point B, and 90% or 100% as the worker reaches (or possibly even passes) that perimeter, as at point A. In another embodiment, a worker who is near the safety perimeter may be subject to 80% or 90% or 100% restraint, but as the worker moves away from that perimeter in a safer direction, the resistance in the lifeline could drop to 10% or 20%, or even retract the lifeline. This feature may be referred to herein as progressive restraint, or applying progressive restraint, and it may be applied based on a worker's location, as described above, or a worker's speed, as described below, or any combination of the two. The eddy-current braking technology as disclosed in U.S. Pat. No. 8,490,751 (Allington et al.), the contents of which is expressly incorporate by reference herein, is believed to have application relative to the features described above.

In another embodiment, an electric motor is coupled to the drum, which may enable the motor to resist deployment of the lifeline, and potentially augment or even replace the spring force that retracts the lifeline into the SRL. The degree of the resistance applied to the lifeline can be increased smoothly and continuously as a worker approaches a perimeter (for example initiating resistance beginning at a specified distance from the perimeter, such as two feet, and continuously increasing the resistance to 100% at the perimeter), or in defined increments (for example 25% between four and three feet from the perimeter, 50% between three and two feet from the perimeter, 75% between two feet and one foot from the perimeter, and 100% at one foot or less from the perimeter). These increments may be as generally shown in FIG. 4 at points C, B, and A. In a further embodiment of the present disclosure, the resistance applied to the deployment of the lifeline could increase linearly, or exponentially (for example doubling the force each foot that the lifeline is extended). Those of skill in the art will recognize that any level of restraint less than 100% (full-stop) restraint can be implemented as described above, at any predetermined distance(s) from the safety perimeter, and that the present disclosure is not limited to the specified ranges set forth above.

In a variation of the embodiment described above, the system may also warn a user by having an SRL provide a series of rapid braking pulses as a worker approaches an area of interest, risk, or concern, much in the same way that anti-lock brakes apply a series of rapid pulses to the brakes of a car, or rumble strips formed in or on a road surface provide a warning to a driver that she or he is nearing the edge of the navigable roadway. The rapid braking pulses can be of any selected duration or frequency, and may apply a small amount of braking force, or an increasing or decreasing amount depending on the path of a user's travel.

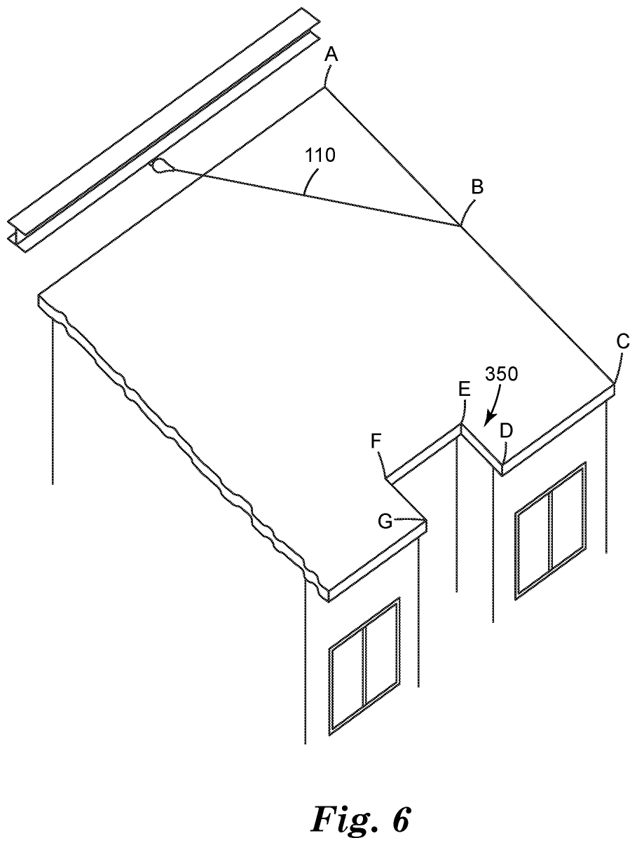

In a further embodiment of the present disclosure, the progressive response is a progressive notification, for example using audio and/or visual and/or tactile or haptic indications of the proximity of a worker to a safety perimeter, optionally together with the progressive restraint feature described above. For example, audio and/or visual and/or tactile or haptic indications can include loud sounds or flashes of white or colored light, which get progressively louder, change frequency, or change color, or vibrations or other haptic indications that increase in intensity or brightness or frequency, as a worker approaches a safety perimeter. These notifications can be provided by outputting a signal from a computing device associated with the SRL to a source of the indications noted, such as a speaker 200, or display 210, or user interface 220, in FIG. 5.

Another aspect of the present disclosure includes calculating or estimating the speed at which a worker is moving, and then using that information to adapt the manner in which the worker is notified and/or restrained by the SRL. For example, an SRL as described above can determine based on the speed at which the lifeline is being extended or retracted, the angular velocity of the SRL, or a combination of the two, the worker's velocity at a point in time. An SRL in accordance with present disclosure can adapt the manner in which the worker is notified that he or she is approaching a safety perimeter so that, for example, a worker moving at a higher velocity is notified earlier, and/or using a louder or higher pitched or more frequently repeating sound or light, whereas a worker moving at a lower velocity is notified later, and/or using a quieter or lower pitched or less frequently repeating sound or light.

Another notification option includes programming the SRL to warn a user by name, which may be a more effective approach than a general auditory warning that can be heard by multiple users in the same area. A further notification option includes programming the SRL to warn a user by spoken words, including in English or in another language selected from among those the SRL is capable of recreating via speaker 200. This could be done by programming the SRL via a user interface 220, or a cell phone or other peripheral device, or a computer system that is operatively connected to the SRL. The notice could be provided via a speaker or other audio device, or wirelessly, for example to the earpiece of a user. Alternatively, or in addition, a worker moving at higher speed can be subject to resistance at a greater distance from the safety perimeter to avoid a larger deceleration force having to be applied close to that perimeter, and a worker moving at a lower speed can be subject to resistance at a lesser distance. Variations on these examples can be implemented by persons of skill in the art, in view of the present disclosure.

Similarly, an SRL in accordance with the present disclosure can adapt the manner in which a worker is restrained when approaching a safety perimeter so that, for example, a worker moving at a higher velocity is restrained (preferably progressively restrained, rather than completely and immediately restrained) at a greater distance from the safety perimeter than a worker moving at a lower velocity. This feature may also be referred to as “rate-dependent restraint,” and can be implemented by an electric motor, or a solenoid-operated braking pad applied to a drum or disc surface, for example.

In another aspect of the present disclosure, an SRL can be provided with one or more cameras 300, 310 that enable the SRL to determine where fall hazards may exist, either independently or together with data provided to the SRL via other means. For example, in one embodiment an SRL may include a single camera that together with data regarding the orientation of the SRL can estimate the location of a fall hazard. An example of such a camera is Ailipu Technology Company part number ELP-USBFHD01M-L21, available from Aliexpress.com. In another embodiment, the SRL can be provided with two cameras that are spaced apart from each other (which may be referred to as parallax cameras), to enable the SRL to generate a more accurate estimate of the location of a fall hazard relative to the SRL or other landmarks. An example of such a camera, which includes a 3D accelerometer, is Seeed Technology part number 101990260, available from Digi-Key Corporation. In another embodiment, the camera or cameras are provided on more than one side of the SRL, to enable the device to obtain information relative to two or more directions. In yet another embodiment, the SRL could be equipped with additional or other sensors such as an IR sensor (which could be particularly useful in estimating the location of IR-emitting landmarks), an example of which is Vishay Semiconductor Opto Division part number TSOP75238WTT, available from Digi-Key Corporation, and/or an acoustic emitter and receiver (which could use sound to estimate distances), and/or a Lidar sensor that emits and receives laser signals to estimate distances or other features of landmarks, or a structured light sensor that emits a structured light signal and receives this light to estimate the distance and direction to those features. These embodiments of the present disclosure, which could be performed by sensors integrated with the SRL or separate from but in wired or wireless communication with the SRL, enable the SRL to teach itself the significant features of the work area, which could then either be used independently to control certain features of the SRL, or used together with other data input to the SRL as described above to control certain features of the SRL.

Another aspect of the present disclosure is the use in an SRL of a camera and a computing device that includes memory, which stores a map. The camera may be used to obtain data regarding objects, surfaces, or other things of interest in its field of view for use with the map, and in a preferred embodiment fall hazards detected by the camera are correlated to points on the map. That information can then be used to provide a response, including a progressive response, to a user of the SRL, all in a manner described herein.

A further aspect of the present disclosure relates to a different manner or method of teaching an SRL regarding an area of interest. (The term teaching is used to describe this approach, but viewed from the perspective of the SRL it could also be referred to as learning.) The method as generally illustrated in FIG. 6 may include the steps of providing an SRL that includes sensors to determine the orientation (azimuth angle) of the SRL and the length of the lifeline 110 that has been extended, taking the end of the lifeline that is or would be connected to a harness (the harness end) to a first location A in the area of interest, transmitting a signal to the SRL to record that location, moving along a path to a second location B in the area of interest, transmitting a signal to the SRL to record that location, and continuing to as many additional locations are necessary to map the area of interest. In that embodiment, which may be referred to as an intermittent teaching mode, the SRL would typically then extrapolate or interpolate to determine the perimeter. One example of a sensor that may be useful to determine orientation, because it includes a three-axis accelerometer and a three-axis magnetometer, is Xsens part number MTi1, available from Mouser Electronics. One example of sensors to infer the length of cable deployed by an SRL includes hall effect sensors such as Diodes Incorporated part number AH183-WG-7, and neodymium magnets such as K&J Magnetics, Inc. part number BX021, available from kjmagnetics.com.

In another embodiment, the SRL could be put into a “learn mode,” after which a user could walk the perimeter with the cable to “teach” the SRL the perimeter of interest, after which the SRL could exit the “learn mode.” This may be referred to as a continuous teaching mode. In either embodiment, the SRL could then be put into a use mode, whereby the data collected and used to represent a map or safety perimeter map could be used by the SRL. In many situations, the locations will be locations of the desired minimum and/or maximum extent of the lifeline, for example the nearest location representing a fall hazard, one example of which is between E and F in FIG. 6, or the farther corner(s) of the area, such as at C in FIG. 6. In other situations, one may teach the SRL using this technique to identify the perimeter of fall hazards or other keep-out areas that exist within the perimeter of the area, such as stairwells or elevator shafts. In an additional variation of the present disclosure, if an additional perimeter map is collected by the SRL and the SRL determines that the second map area is within an earlier perimeter map, or vice versa, the SRL could designate the inner map as a fall hazard, for example one that represents an open stairwell, or an elevator shaft, or an area with falling debris or other potential hazards. In other words, the comparison of two or more perimeter maps in which one at least partially overlaps another can result in an integrated area safety map, reflecting at least one feature of each of the two (or more) maps, with clear potential benefits to users of the SRL.

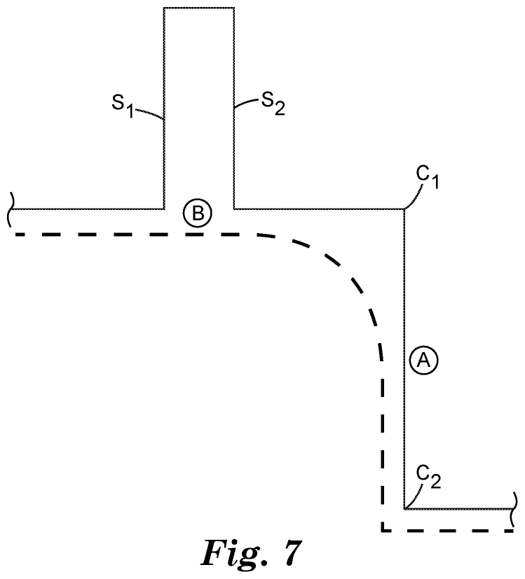

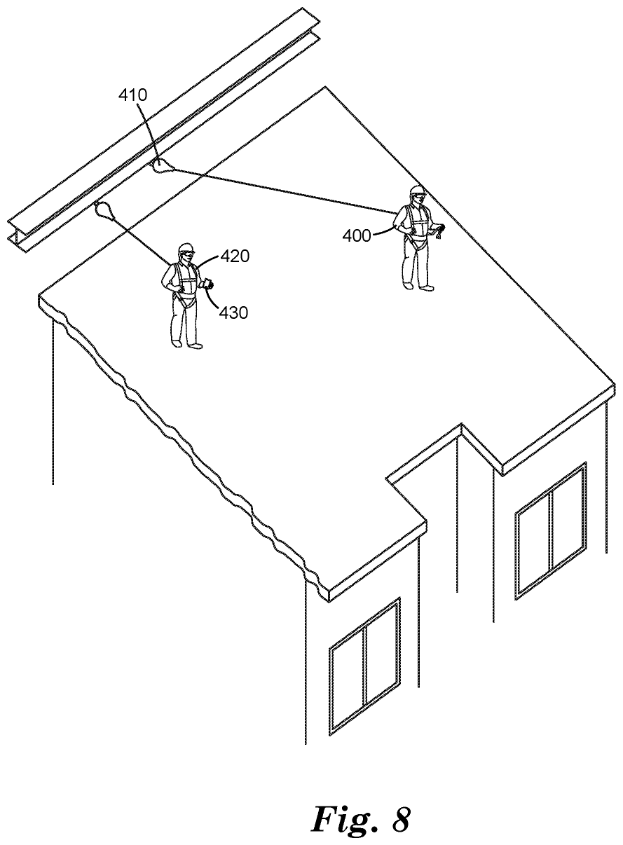

In defining the perimeter of interest, the SRL may be programmed to reflect certain additional rules designed to improve user safety or system performance. For example, the SRL may be programmed to reflect that the perimeter it is taught will be approximately a fixed distance inside the actual outer limit of the area of interest. For example, the SRL may be programmed to reflect that a user teaching a perimeter will stand approximately two feet inside the actual outer limit of the area of interest at all points that are taught to the SRL. In an additional aspect of the present disclosure, the SRL may be programmed to apply certain rules to translate an actual perimeter into a safe perimeter. For example, as shown in FIG. 7, the solid line indicates the plan view of the perimeter of a raised surface, including a narrow extension B, an outside corner C₁, and an inside corner C₂. If a conventional SRL permits the user to walk out onto the narrow extension, a fall event to either side one (S₁) or side two (S₂) could be dangerous because the user could fall toward the structure, as could a fall near the outside corner (C₁), where the user could swing toward the inside corner (C₂) of the structure. The SRL of the present disclosure can thus redefine the actual perimeter stored in memory as a safe perimeter (shown in dashed lines in FIG. 7), by (a) bypassing an extension of the actual perimeter to prevent the user from walking to where a swing-fall may occur, as shown at B, or (b) moving the perimeter inward to form an arc or other suitable path that prevents the user from walking to where a swing-fall may occur, as shown at A, or both, and/or any other variations, depending on where the SRL is anchored. If a user were to require access to an area considered to be outside the safety perimeter, but within the actual perimeter, the system could be overridden in the manner described below.

An additional feature of certain embodiments of the present disclosure is the use of the same SRL to map the perimeter of an area of interest as is subsequently used by a person for fall protection purposes in or on that area. This is advantageous because it tends to negate or at least mitigate measurement accuracy errors that could otherwise be expected to occur if the device or system used to map the perimeter is different from, and therefore exhibits different characteristic measurement errors than, the device or system used by a person for fall protection purposes. Because in a scientific sense this approach requires that the device exhibits repeatability, but not necessarily accuracy, the device may be simpler, less expensive, and more reliable to manufacture. For example, in this embodiment it is less important whether the length of an extended lifeline is 21 feet or 23 feet than it is that the device record the distance (whatever it is) the same way every time, and respond accordingly.

The signals transmitted to the SRL, or a computing device associated with the SRL, can be sent via any suitable system, such as Bluetooth, cellular telephony, WiFi, LoRa, or Zigbee. The lifeline itself could also include a communications line, such that the signal sent to the SRL when teaching it about the area of interest is transmitted via that line.

In yet another aspect of the present disclosure, the computing device associated with the SRL once taught the area of interest can output a graphic representation of that area, for correction, modification or confirmation by a user. For example, the SRL or a peripheral device such as a display or a cellular telephone could display a graphical image of the roof or other work surface that was taught to the SRL, prior to a user attaching the harness end of the lifeline to the harness and commencing work.

Another feature of certain aspects of the present disclosure relates to the ability to prevent (or reduce the harm associated with) swing falls. Swing falls are known in the field to have the potential to cause harm to workers, because even once the worker falls from a location (such as the far corner of a roof), he or she may swing from that location under or past the anchorage point for the SRL, along or toward the ground, and/or toward another portion of the structure. In one embodiment, the SRL limits the length of the extended lifeline when the calculated impact energy of a person with a structure or the ground or another surface, if a fall event were to occur, would exceed a predetermined level. That level may be the level at which significant anatomical damage can be expected to occur in most people. Human factors studies provide that information.

In a related embodiment of the present disclosure, a user can when teaching the SRL about the area of interest input the actual or estimated extent of the fall that could occur at one or more locations of interest. For example, if a building has a flat or sloped roof area that terminates two feet above ground level on one side, but due to changes in grade has a roof area on another side that terminates twenty feet above ground level, a user could input that information to the SRL via an interface, for example via a graphical user interface associated with the SRL, or a cell phone, or a computer system to which the SRL is operationally connected. The SRL could then be programmed to permit a worker working in the first area to approach (or perhaps even go beyond) the safety perimeter, but not in the second area. Because roof (or in general, work surface) arrangements vary, and the local ground grade also varies, this feature may be described in terms of the net distance between a work surface and the ground, at one or more locations. Described another way, the SRL may restrict a user's mobility, either progressively or completely, based on a calculation of the user's calculated impact energy as it relates to local topographical features.

In another related embodiment, the SRL of the present disclosure can be adapted to calculate the potential energy of a user (from a fall perspective) based on the change in the height of the user on the elevated surface compared to the final height of the user if the user were to fall at that location and the fall were arrested under the then-current conditions (lifeline length, position relative to the perimeter of the surface, etc.). If that energy level exceeds a predetermined level, as described above, the SRL can be adapted to notify the user, or slow or prevent any further extension of the lifeline, or a combination of these and/or other actions.

Another embodiment of the present disclosure provides some flexibility in the use of an SRL, when appropriate. As noted in the example above, there may be circumstances when there is little or no fall hazard in one area, but a significant fall hazard in another area, associated with an SRL. In this embodiment of the disclosure, as shown in FIG. 8, the worker 400 using the SRL 410, or another person 420, can override the SRL's restraint system to enable a worker to go a defined additional distance toward (or to, or potentially even beyond) that perimeter. For example, if a worker 400 near the edge of a roof that is less than two feet above ground level is restrained by the SRL prior to reaching his or her objective, the worker (or another person 420, which may be desirable for safety reasons) could initiate a limited override of the SRL to permit the SRL to pay out an additional length of the lifeline, such as one foot. This could be implemented using a signal transmitted in the same manner as described above in regard to teaching the SRL about the area, for example with a device (such as a cellular telephone) 430 equipped with via Bluetooth, Wifi, LoRa, or Zigbee. The SRL could be adapted to extend the additional (or override) length of lifeline via an eddy-current braking system, or another mechanical system implemented in the SRL.

In order to preserve safe conditions, the SRL could refuse a request to override, for example because the potential consequence of a fall (including a swing fall) from a certain location would be serious for the worker. In other embodiments, the worker himself or herself could be prevented from overriding the SRL, and only another worker (for example a supervisor or safety manager) could be permitted to grant an override. In a further optional feature, the SRL could be programmed to stop the override after a certain limited period of time, and/or if the user were to leave a predetermined region in which the override was granted.

This limited SRL override feature may be advantageous in that workers who encounter fixed limits on their ability to traverse a work surface may be more likely to continue to use an SRL if those limits can be appropriately overridden than if they cannot.

The SRL of the present disclosure may also be used to predict based on a user's movement when she or he will approach and potentially fall from an edge. This can be a significant advantage relative to systems that rely only on determinations of a user's position. For example, in FIG. 6, if a user is traveling at the location and in the direction indicated by arrow 350, the SRL based on the sensors described above can determine that a fall event may occur if the user continues moving in the same direction. This could occur if a user is distracted, walking backwards, or carrying or approaching something that obstructs his or her field of view, for example. The SRL of the present disclosure may then warn the user using one or more of the signals described above, such as an audio signal (potentially including the name of the person connected to that SRL, or warning in a language selected in advance or by default, as described herein) or a haptic signal.

A number of embodiments of the present disclosure have been described herein with reference to certain examples. The scope of the present invention is not limited to those examples. For example, components described as being a part of an SRL could be a part of a device or assembly used together with an SRL to provide the same effect. For example, an azimuth angle sensor could be a part of a bracket or other anchoring assembly rather than an SRL, but provide data to the SRL in the same manner as though it were an integrated part of the SRL. Similarly, a speaker could be part of an SRL, or could be a peripheral device that produces a sound when initiated by the SRL or another peripheral associated with an SRL. These and other variations will be understood by a person of skill in the art.

1.-9. (canceled)

10. A self-retracting lifeline (SRL) comprising:
a. a lifeline having a distal end for connection to a user;
b. a one sensor; and
c. a computing device comprising a processor and a memory, the memory including instructions that when executed by the computing device cause the computing device to use data obtained from the sensor to determine at least two locations of the distal end of the lifeline, and the SRL to apply a progressive response based on the locations.

11. The self-retracting lifeline of claim 10, wherein the progressive response comprises progressive restraint of the lifeline.

12. The self-retracting lifeline of claim 10, wherein the progressive response comprises progressive notifications.

13. The self-retracting lifeline of claim 10, wherein the SRL further comprises:
a. a sensor adapted to determine the amount of lifeline that has been extended from the SRL; and
b. a sensor adapted to determine the azimuth angle of the lifeline extended from the SRL.

14. The self-retracting lifeline of claim 10, wherein the SRL further comprises a sensor adapted to determine the tension in the lifeline.

15. The self-retracting lifeline of claim 10, wherein the memory includes a map representing at least a portion of a safety perimeter.

16. The self-retracting lifeline of claim 15, wherein the computing device is adapted to compare the location to the map, and the progressive response is progressive restraint applied to the lifeline based on the location relative to the map.

17. The self-retracting lifeline of claim 15, wherein the progressive response is progressive restraint applied to the lifeline that is less than 100% when the location is within the safety perimeter.

18. The self-retracting lifeline of claim 11, wherein the computing device is adapted to determine a succession of locations, and the SRL is adapted to increase restraint continuously as the location approaches the safety perimeter.

19. The self-retracting lifeline of claim 11, wherein the computing device is adapted to determine a succession of locations, and the SRL is adapted to increase restraint in increments as the location approaches the safety perimeter.

20. The self-retracting lifeline of claim 11, wherein the restraint applied is greater at a first location than at a second, subsequent location.

21. The self-retracting lifeline of claim 11, wherein the restraint applied is lesser at a first location than at a second, subsequent location.

22. The self-retracting lifeline of claim 15, wherein the computing device is adapted to compare the locations to the map, and the progressive response is to provide progressive notifications based on the locations relative to the map.

23. The self-retracting lifeline of claim 15, wherein the progressive response is to provide progressive notification that is less than 100% of the potential notification when the location is within the safety perimeter.

24. The self-retracting lifeline of claim 15, wherein the computing device is adapted to determine a succession of locations, and the progressive response is progressive notification that is adapted to increase the intensity, brightness, or frequency of the notification in increments as the location approaches the safety perimeter.

25. The self-retracting lifeline of claim 12, wherein the progressive response is progressive notification, and the intensity, brightness, or frequency of the notification is greater at a first location than at a second, subsequent location.

26. The self-retracting lifeline of claim 12, wherein the progressive response is progressive notification, and the intensity, brightness, or frequency of the notification is lesser at a first location than at a second, subsequent location.

27.-78. (canceled)
